(19) United States
(12) Patent Application Publication
(10) Pub. No.: US 2025/0161964 A1
(43) Pub. Date: May 22, 2025

(54) SEAM SEALER ADAPTER FOR SPRAY GUN

(71) Applicant: 3M INNOVATIVE PROPERTIES COMPANY, St. Paul, MN (US)

(72) Inventors: Scott D. Gullicks, River Falls, WI (US); Ryan P. Marrinan, Lino Lakes, MN (US)

(21) Appl. No.: 18/874,861

(22) PCT Filed: Jun. 14, 2023
(86) PCT No.: PCT/IB2023/056162

§ 371 Date: Dec. 13, 2024

Related U.S. Application Data
(60) Provisional application No. 63/352,185, filed on Jun. 14, 2022.

(51) Int. Cl. B05B 7/24

(52) U.S. Cl. CPC B05B 7/241; B05B 7/2424; B05B 7/2478

(57) ABSTRACT

Aspects of the present disclosure relate to a method and system. The method includes obtaining a spray gun platform (206) and a spray gun nozzle assembly (208). The method can include assembling the spray gun platform (206) and the spray gun nozzle assembly such that the nozzle gas inlet is coupled with the platform gas passageway (228). The method can also include coupling an adhesive cartridge (204) containing the adhesive to the nozzle liquid inlet. The adhesive cartridge (204) is configured to be pressurized from a gas source. The method can also include activating a trigger of the spray gun platform (206).

### BACKGROUND

Applicator systems for dispensing adhesives can achieve a texture when dispensed. These applicator systems can allow the adhesive to be applied to a substrate by either spraying the adhesive or caulking the adhesive. Depending on the application method, the applicator system can provide certain textures such as a spray texture or a ripple texture. These applicator systems can be designed to be reusable and have metal components that are cleaned after every use.

### BRIEF SUMMARY

The applicator systems used to apply adhesives can be very difficult to keep clean due to the curing of the adhesive in small intricate passageways. For example, when the nozzle liquid passageway has allowed air to enter and cure the adhesive in the liquid passageway of the applicator system, then it becomes almost impossible to clean and remove the cured adhesive from the liquid passageway. This results sometimes in the entire applicator system being disposed of.

While some spray gun systems (such as those sold by 3M under the trade designation “Performance Spray Gun”) are used to spray paints, these spray gun systems can have issues with higher viscosity substances such as adhesives. When the spray gun system is operating (e.g., when a needle valve is opened or otherwise allowing liquid to flow through), the pressure of the spray gun system measured at a gas inlet is generally between 18 PSI to 30 PSI, which is not enough to draw adhesive using the venturi effect.

To compensate, some spray gun systems can pressurize the paint containers, but these pressurized systems generally operate at 3 to 5 PSI (measured at an adhesive cartridge container gas inlet), which is not enough to allow dispensing of adhesives.

Aspects of the present disclosure relate to a system. The system can include a spray gun nozzle assembly comprising a nozzle body portion having a nozzle gas passageway and a nozzle liquid passageway formed therein. The nozzle gas passageway is formed between a nozzle gas inlet and a nozzle gas outlet. The nozzle liquid passageway is formed between a nozzle liquid inlet and a nozzle liquid outlet. The nozzle body portion comprises a first connector format at the nozzle liquid inlet. The nozzle liquid inlet and nozzle gas inlet are arranged obliquely relative to each other and are not coaxial with one another.

The system can also include an adhesive adaptor having a first end configured to form a fluid-tight connection with the nozzle liquid passageway, the adhesive adaptor having a first adaptor opening formed therein at the first end and a second adaptor opening formed therein opposite of the first adaptor opening at a second end. The first adaptor opening is configured to form a fluid-tight seal with the nozzle liquid inlet. The first adaptor opening is also configured to form a fluid-tight seal with an adhesive cartridge.

The system can also include an adhesive cartridge container comprising a container body portion further comprising a first container opening and an adhesive cartridge container gas inlet, wherein the first container opening is configured to couple with the second adaptor opening, the adhesive cartridge container gas inlet is configured to receive pressurized gas. When assembled, the system is configured to dispense an adhesive having a viscosity of at least 4000 centipoise. For example, the system is configured to dispense the adhesive in a bead, or a spray.

Aspects of the present disclosure relate to a method. The method includes obtaining a spray gun platform and a spray gun nozzle assembly. The spray gun nozzle assembly is detachable from the spray gun platform. The spray gun nozzle assembly includes a nozzle liquid passageway formed between a nozzle liquid inlet and a nozzle liquid outlet, and a nozzle gas passageway formed between a nozzle gas inlet and a nozzle gas outlet. The nozzle liquid inlet and nozzle gas inlet are not arranged along the same axis. The spray gun platform includes a platform gas passageway formed therein. The platform gas passageway is configured to fluidically couple to a gas source. The nozzle gas inlet is configured to releasably couple with the platform gas passageway.

The method can include assembling the spray gun platform and the spray gun nozzle assembly such that the nozzle gas inlet is coupled with the platform gas passageway. The nozzle liquid outlet can be opened by a needle valve on the spray gun platform. The spray gun platform is not configured to contact an adhesive except through the needle valve.

The method can also include coupling an adhesive cartridge containing the adhesive to the nozzle liquid inlet. The adhesive cartridge is configured to be pressurized from the gas source. The method can also include activating a trigger of the spray gun platform. Activating the trigger causes the needle valve to open and thereby dispensing the adhesive through the nozzle liquid outlet. The method can also include removing the spray gun nozzle assembly from the spray gun platform.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an adhesive cartridge in accordance with one embodiment.

FIG. 2 illustrates a block diagram of a system in accordance with one embodiment.

FIG. 3 illustrates an assembly having a gravity-fed configuration in accordance with one embodiment.

FIG. 4 illustrates a system that includes the assembly from FIG. 3 in accordance with one embodiment.

FIG. 5 illustrates the system of FIG. 4 except having an adhesive bead nozzle in accordance with one embodiment.

FIG. 6 illustrates an assembly having a pressure-fed configuration in accordance with one embodiment.

FIG. 7 illustrates a system including the assembly from FIG. 6 in accordance with one embodiment.

FIG. 8A illustrates an assembly in a partially assembled state in accordance with one embodiment.

FIG. 8B illustrates the assembly from FIG. 8A in an assembled state in accordance with one embodiment.

FIG. 9 illustrates an enhanced view of the deformable sealing surface from the assembly of FIG. 8B in accordance with one embodiment.

FIG. 10A illustrates an example of a deformed sealing surface in accordance with one embodiment.

FIG. 10B illustrates an example of a deformed sealing surface in accordance with one embodiment.

FIG. 10C illustrates an example of a deformed sealing surface in accordance with one embodiment.

FIG. 11A illustrates an assembly in a partially assembled state in accordance with one embodiment.

FIG. 11B illustrates the assembly of FIG. 11A in an assembled state in accordance with one embodiment.

FIG. 12 illustrates a flowchart of a method 1200 in accordance with one embodiment.

### DETAILED DESCRIPTION

Aspects of the present disclosure relate to a system including a spray gun platform and spray gun nozzle assembly (e.g., a nozzle cartridge) and method of using the system to dispense an adhesive from an adhesive cartridge. When finished, a user can remove the nozzle cartridge and replace the nozzle cartridge with a second nozzle cartridge.

Aspects of the present disclosure can allow high viscosity, curable fluids like adhesives to

be able to be sprayed through a spray gun nozzle assembly. A pressure chamber can couple a plastic or aluminum adhesive cartridge directly with a disposable spray gun nozzle assembly that can be integrally attached to the front end of a spray gun platform.

Aspects of the present disclosure can relate to a spray gun system having an adhesive cartridge container having an adhesive cartridge container gas inlet. The adhesive cartridge container can be configured to be pressurized at least 20 PSI as measured at the adhesive cartridge container gas inlet. Further, the spray gun system as a whole can have an operating pressure of at least 50 PSI as measured at the gas inlet.

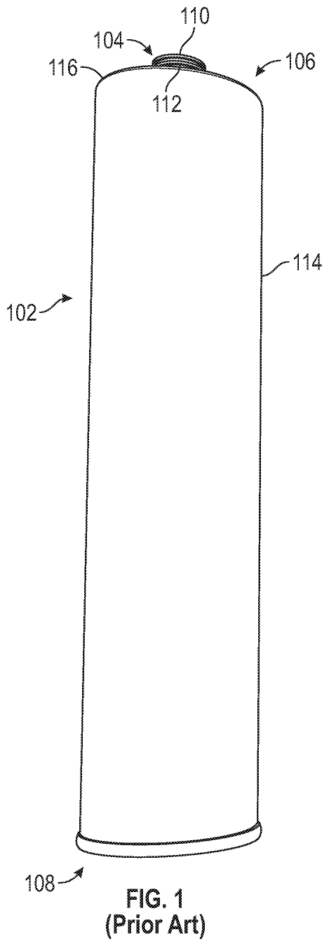

FIG. 1 illustrates an adhesive cartridge 102 useful in the present disclosure. Examples of adhesive cartridge 102 are commercially available from 3M (Saint Paul, MN).

In at least one embodiment, the adhesive cartridge 102 can include an attachment format 104. The attachment format 104 can be formatted to couple with an adhesive adaptor and/or an adhesive cartridge container. For example, the attachment format of an adhesive cartridge container (not shown) can include a complementary attachment format on the inside surface configured to couple with the attachment format 104.

The adhesive cartridge 102 can include a first end 106 and a second end 108. In at least one embodiment, the attachment format 104 is positioned on at the first end 106.

In at least one embodiment, the adhesive cartridge 102 can include a spout wall 112. The spout wall 112 can have a rim surface 110 that is planar and does not form any projection with respect to the surrounding surfaces. For example, the rim surface 110 can be a top flat surface and be established by a plane of a major surface of the rim. In at least one embodiment, the spout wall 112 can also include one or more ribs projecting radially from the spout wall 112 to aid in scaling. In at least one embodiment, the ribs can be the attachment format 104.

The adhesive cartridge 102 can also include a tubular wall 114, and a wall 116 between the spout wall 112 and the tubular wall 114. The wall 116 can be oriented askew from the tubular wall 114 (e.g., perpendicular). In at least one embodiment, the wall 116, spout wall 112, and wall 116 can be formed of a semi-rigid or rigid material such as metal, plastic, or paperboard such that it is self-supporting.

Adhesive cartridge 102 is one type of form factor for an adhesive cartridge. Other adhesive cartridges can be in the form of a caulk tube which can have a rigid tip configured to resist fluid pressure from the adhesive. Although the adhesive cartridge 102 is shown, other potential embodiments can be in the form of a sausage pack with non-rigid packaging.

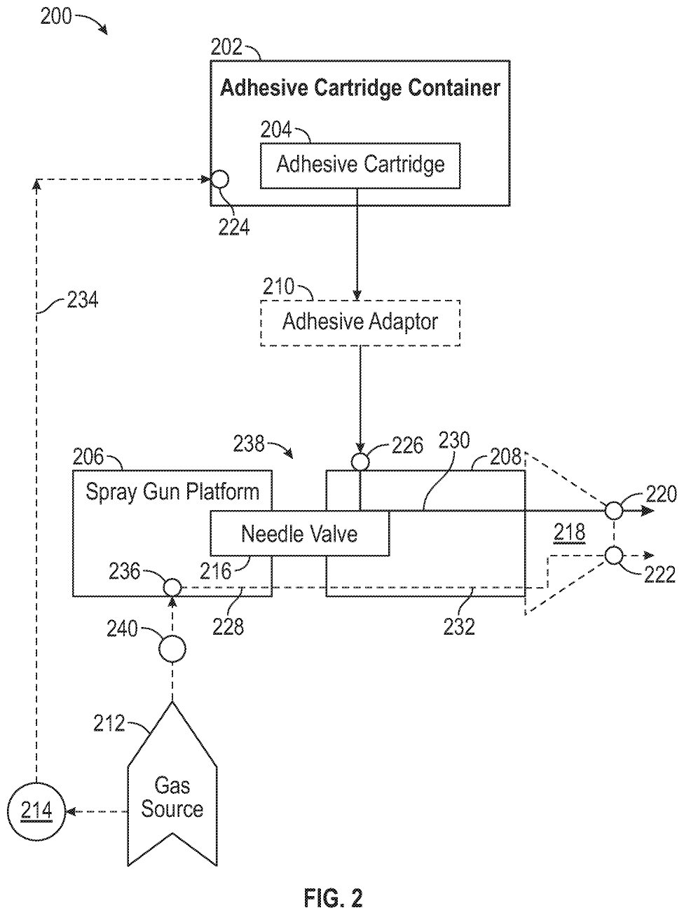

FIG. 2 illustrates a block diagram of a system 200. An aspect of the system 200 is the spray gun nozzle assembly 208 being used to dispense the adhesive through an internal nozzle liquid passageway. The spray gun nozzle assembly 208 can be discarded after use to avoid an intensive cleaning process of a standard adhesive dispensing system and use conventional spray gun equipment designed for automotive paints.

The system 200 can include a spray gun platform 206, spray gun nozzle assembly 208, and an adhesive cartridge 204.

The spray gun platform 206 and can be commercially available under the trade designation Performance Spray Gun by 3M (Saint Paul, MN). The spray gun platform 206 can include a trigger that actuates a needle valve 216 and activates a gas valve 236 to release gas from a gas source 212. The spray gun platform 206 can differ from other spray guns in that the spray gun platform 206 has platform gas passageways 228 formed within the spray gun platform 206. For example, the spray gun platform 206 can have a first platform gas passageway 228 that is configured to fluidically couple with a nozzle gas passageway formed in the spray gun nozzle assembly 208. In at least one embodiment, the spray gun platform 206 is described in U.S. Pat. No. 11,154,894 to Hayward et al., specifically with reference to FIG. 18. For example, the spray gun platform 206 includes a handle, a gas valve 236, and a connection for an external gas source 212, a spray gun platform, a liquid needle adjustment knob, a shaping gas control knob, and combinations thereof. The spray gun platform 206 can include walls separating different platform gas passageways 228.

In at least one embodiment, the platform gas passageway 228 is configured to fluidically couple to a gas source 212.

Aspects of the present disclosure include an adjustable adhesive cartridge container pressure valve 214 (independent from the spray gun platform 206) that provides controlled gas to the adhesive cartridge container gas inlet 224 (which may pressurize a piston) which drives the adhesive through a series of passageways integral to the disposable nozzle. The adhesive cartridge container pressure valve 214 also allows for another route of controlled gas through the spray gun platform 206 which can be distributed through two different main chambers in the platform gas passageway 228 and/or the spray gun nozzle assembly 208, the atomizing gas chamber and the shaping gas chamber. Varying the pressures of each of adhesive cartridge container pressure valve 214 and the pressure regulator 240 can allow the user to vary the appearance of the adhesive as it exits the nozzle.

The spray gun nozzle assembly 208 can also be similar to that described in U.S. Pat. No. 11,154,894 to Hayward et. al. or U.S. Pat. No. 11,154,884 to Hayward et al. As described herein, the spray gun nozzle assembly 208 can be in a gravity-fed configuration or a pressure-fed configuration. The spray gun nozzle assembly 208 can also have an adhesive adaptor 218 attached thereon. In at least one embodiment, the adhesive adaptor 218 can be an air cap with air horns. In at least one embodiment, the adhesive adaptor 218 can include a modified air cap that is configured to not discharge gas and is configured to discharge adhesive without gas (e.g., from a ripple tip).

The spray gun nozzle assembly 208 can include a liquid inlet 226 that leads into the nozzle liquid passageway 230. Opposite the liquid inlet 226 can be the liquid outlet 220. In at least one embodiment, the entire nozzle liquid passageway 230 can be outside of the spray gun platform 206 and self-contained within the spray gun nozzle assembly 208. For example, the liquid inlet 226 can be outside of the spray gun platform 206 and fluidically coupled to the nozzle liquid passageway 230 of the spray gun nozzle assembly 208.

In at least one embodiment, the nozzle gas inlet 238 of the spray gun nozzle assembly 208 leading to a nozzle gas passageway 232 is configured to releasably couple with the platform gas passageway 228. Opposite from the nozzle gas inlet 238 is the nozzle gas outlet 222. In at least one embodiment, the spray gun platform 206 does not contact the liquid in the nozzle liquid passageway 230 except through only the needle valve 216. In at least one embodiment, the nozzle liquid passageway 230 is configured to directly couple to a liquid outside of the spray gun platform.

The liquid inlet 226 of the spray gun nozzle assembly 208 can further couple to the adhesive cartridge 204 and/or the adhesive cartridge container 202 via the adhesive adaptor 210 (optional). In at least one embodiment, the adhesive cartridge 204 can couple directly into the liquid inlet (or via an optional adhesive adaptor 210). In at least one embodiment, the adhesive cartridge container 202 is configured to be pressurized sufficient to cause the adhesive cartridge 204 to dispense through the liquid outlet 220.

In at least one embodiment, the gas source 212 can be split such that gas is supplied to

both the spray gun platform 206 and the gas tube 234 via the adhesive cartridge container pressure valve 214. The adhesive cartridge container pressure valve 214 can further transport the gas via a gas tube 234 into the adhesive cartridge container gas inlet 224.

In at least one embodiment, the gas to the spray gun platform 206 can be optional. For example, the gas source 212 can be fed into the adhesive cartridge container gas inlet 224. As the trigger of the spray gun platform 206 is activated, the needle valve 216 can be actuated such that the liquid outlet 220 is open. The pressure from gas source 212 can force the adhesive in the adhesive cartridge 204 into the liquid inlet 226 and through liquid outlet 220 via the nozzle liquid passageway 230. In at least one embodiment, the gas valve 236 of the spray gun platform 206 can activate a flow of gas for the platform gas passageway 228 and allows the pressurized gas from gas tube 234 to dispense the adhesive through adhesive adaptor 218 simultaneously (such as when using sprayable adhesives).

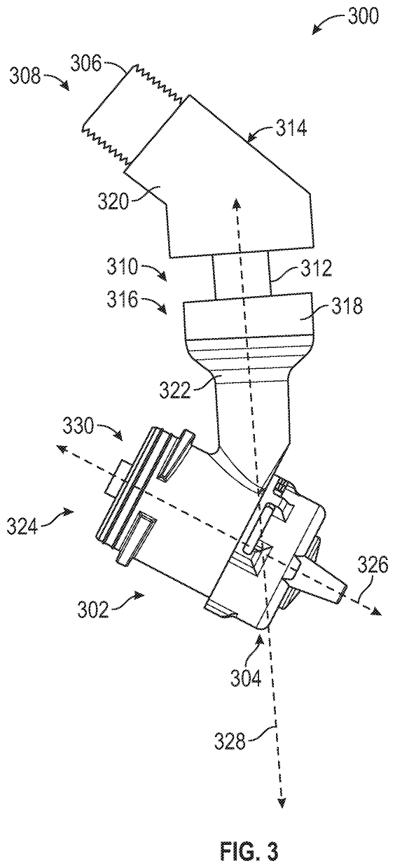

FIG. 3 illustrates an assembly 300 that includes a spray gun nozzle assembly 302, an air cap 304, and adhesive adaptor 314 attached to the spray gun nozzle assembly 302.

The spray gun nozzle assembly 302 is an embodiment of spray gun nozzle assembly 208. The air cap 304 is attached to the spray gun nozzle assembly 302. An air cap 304 can be particularly useful in sprayable adhesive formulations. As shown in FIG. 3, both the spray gun nozzle assembly 302 and air cap 304 are commercially available under the trade designation Performance Spray Gun by 3M (Saint Paul, MN).

The spray gun nozzle assembly 302 can include a nozzle body portion 322, which can further include a nozzle liquid inlet 316 and a first connector format 318 disposed adjacent to the nozzle liquid inlet 316. For example, the first connector format 318 can be funnel-shaped. For example, the first connector format 318 can include an inner portion (not shown) that has a smaller diameter than the largest diameter of the first connector format 318. A tubular wall can form both the inner portion and the keyed portions of the first connector format 318. In at least one embodiment, the inner portion can form the nozzle liquid inlet 316. As shown in FIG. 3, the first connector format 318 is configured for gravity-fed operation.

The nozzle body portion 322 can also include a nozzle gas inlet 324. In at least one embodiment, the nozzle liquid inlet 316 and nozzle gas inlet 324 are arranged oblique or at an angle relative to each other. For example, the nozzle gas inlet 324 can be arranged about the spray axis 326 and the nozzle liquid inlet 316 can be arranged about the liquid axis 328. The angle 330 can be no greater than 90 degrees. In at least one embodiment, the angle 330 is less than 90 degrees.

The assembly 300 can also include an adhesive adaptor 314 which is an embodiment of adhesive adaptor 210. The adhesive adaptor 314 can be configured for forming a fluid-tight connection between an adhesive cartridge container and the nozzle liquid inlet 316. In at least one embodiment, the adhesive adaptor 314 can be fluidically coupled to the inner portion of the nozzle liquid inlet 316. The adhesive adaptor 314 can be tubular in construction (which is shown in the examples, but other constructions are possible) and be formed of a single tubular wall 320. The adhesive adaptor 314 can have a second adaptor opening 306 at a second end 308 and a first adaptor opening 312 at a first end 310. The adhesive adaptor 314 can change directions of the initial fluid path. For example, the angle formed between the second adaptor opening 306 and the first adaptor opening 312 can be less than 180 degrees in an offset configuration. In at least one embodiment, the outer surface of the tubular wall 320 of the second adaptor opening 306 can contact the inner portion of the first connector format 318.

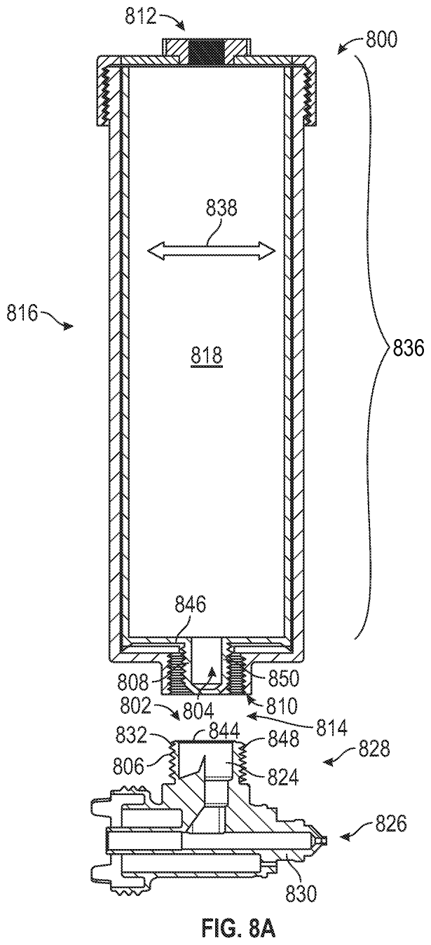

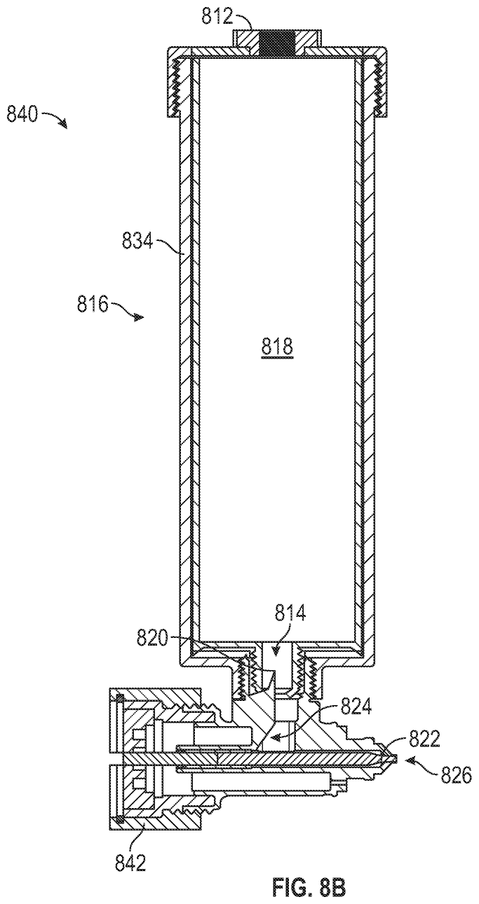

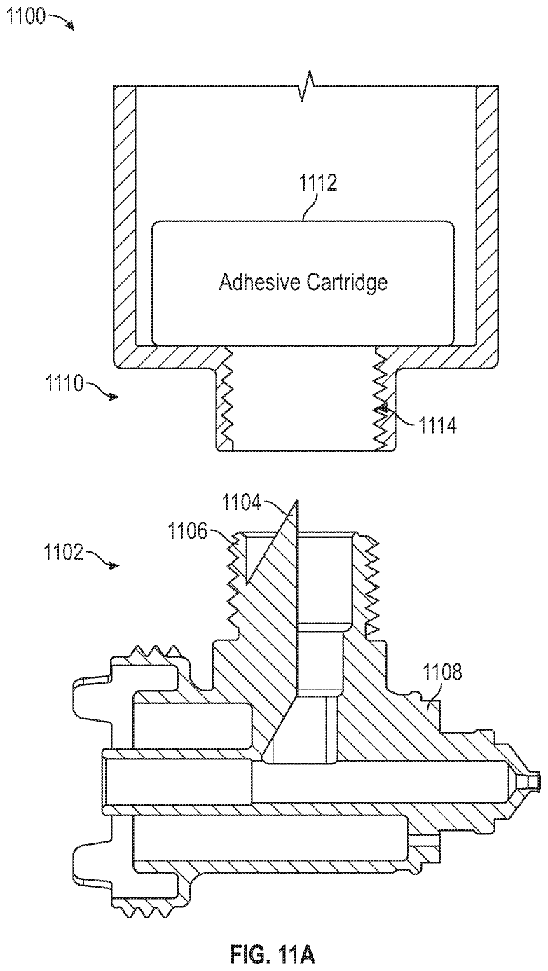

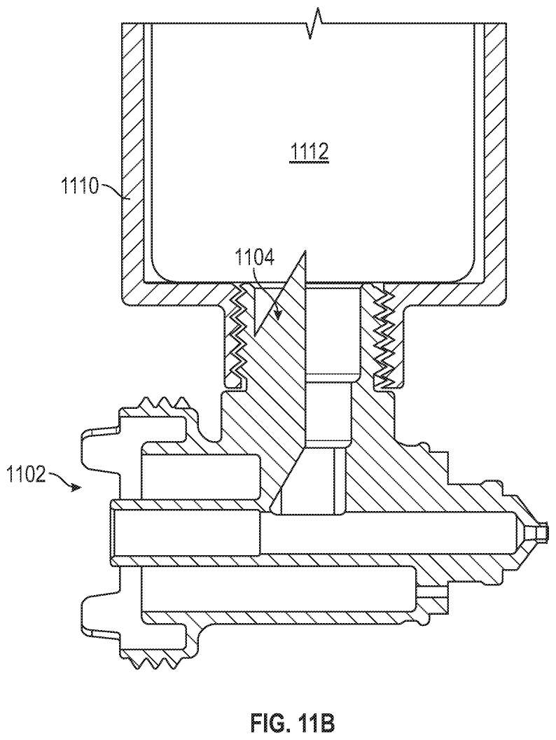

In at least one embodiment, the adhesive adaptor 314 can be integral with the spray gun nozzle assembly 302. For example, the adhesive adaptor 314 can be integrally molded at the same time as the spray gun nozzle assembly 302. Thus, the spray gun nozzle assembly 302 can be configured to directly connect to the adhesive cartridge container (not shown) similar to the connection in FIG. 8A and FIG. 11A.

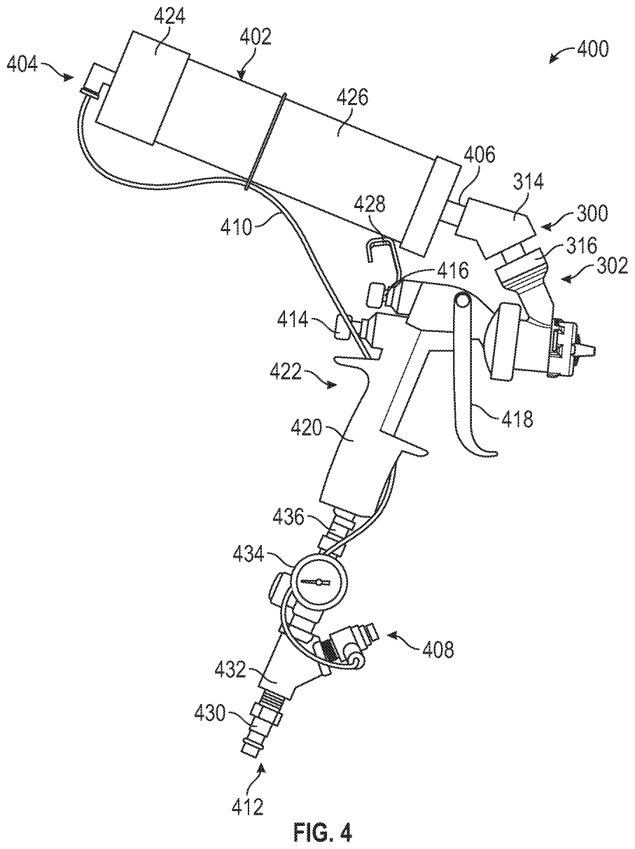

FIG. 4 illustrates a system 400 that includes the assembly 300 from FIG. 3. The assembly 300 can couple with the spray gun platform 422 and an adhesive cartridge container 402.

The spray gun platform 422 can be commercially available under the trade designation Performance Spray Gun from 3M (Saint Paul, MN). The spray gun platform 422 can include a trigger 418, handle 420, liquid needle adjustment knob 414, and shaping gas adjustment knob 416. The nozzle liquid passageway can be separate from the spray gun platform 422 and the nozzle gas passageway can couple with the platform gas passageway from the spray gun platform 422.

The system 400 can also include an adhesive cartridge container 402. The adhesive cartridge container 402 can be configured to receive an adhesive cartridge (not shown). In at least one embodiment, the adhesive cartridge container 402 can be configured to receive a range of gas pressure from an external gas source 412. For example, the operable gas pressure can be between 0 and 100 PSI inclusive, between 1 and 100 PSI inclusive, between 0 and 75 PSI inclusive, or between 0 and 50 PSI inclusive.

In at least one embodiment, the adhesive cartridge container 402 can include a container body portion 426. The container body portion 426 can be tube-shaped in one example and be formed of a tubular wall. The container body portion 426 can further include a first container opening 406 and an adhesive cartridge container gas inlet 404.

The first container opening 406 can be configured to couple with the second adaptor opening of the adhesive adaptor 314. In at least one embodiment, the first container opening 406 can include an attachment format, the adhesive adaptor 314 and/or the spray gun nozzle assembly 302 can include a complementary attachment format on the inside surface configured to couple with the attachment format.

The gas from an external gas source 412 can be supplied via a plurality of valves that can each be adjusted independently from each other. For example, the system 400 can include a splitter inlet 430 to receive gas from the external gas source 412. The splitter inlet 430 can sometimes receive whatever line pressure (from a facility) which may be about 100 psi depending on the facility. The splitter inlet 430 can provide gas flow to a splitter 432 that splits into adhesive cartridge container pressure valve 408, and pressure regulator 434.

The adhesive cartridge container pressure valve 408 can be external from the spray gun platform 422 and/or spray gun nozzle assembly 302. For example, the adhesive cartridge container pressure valve 408 is not considered integral to spray gun platform 422. In at least one embodiment, the adhesive cartridge container pressure valve 408 can be a pressure regulator or a restrictor, depending on the application. The adhesive cartridge container pressure valve 408 can reduce the pressure from the upstream of the valve to the downstream of the adhesive cartridge container pressure valve 408. In at least one embodiment, the adhesive cartridge container pressure valve 408 can be coupled to the adhesive cartridge container gas inlet 404 via a gas tube 410. In at least one embodiment, the pressure directly adjacent to the downstream of adhesive cartridge container pressure valve 408 can depend on the application.

The pressure regulator 434 is shown with a dial that can be adjusted by a user. The

pressure regulator 434 can lead to the spray gun gas inlet 436. In at least one embodiment, upstream region directly adjacent to pressure regulator 434 can have a pressure similar to the input line pressure. The downstream region can have a spray gun pressure that is configured for the spray gun system 400. For example, the spray gun gas inlet 436 can have a pressure that depends on the application. In a paint spraying operation when the spray gun platform 422 and spray gun nozzle assembly 302 are used as a paint spray gun, the pressure at the spray gun gas inlet 436 can be around 20 PSI.

The pressure regulator 434 and the adhesive cartridge container pressure valve 408 can be independently adjustable depending on the application. In a paint spraying operation when the spray gun platform 422 and spray gun nozzle assembly 302 are used as a paint spray gun and a paint container is an H/O cup, then pressure at a paint container inlet (similar to adhesive cartridge container gas inlet 404) can be around 3 to 5 PSI.

For example, in a first application involving providing a bead of adhesive, the adhesive cartridge container pressure valve 408 can be set to at least 35 PSI and the pressure regulator 434 can be set to a negligible pressure. In a second application involving spraying sprayable adhesive, the adhesive cartridge container pressure valve 408 can be set to at least 6 PSI (e.g., between 6 PSI and 12 PSI, inclusive) and the pressure regulator 434 can be set to at least 30 PSI, at least 35 PSI, or at least 40 PSI measured at the spray gun gas inlet 436. Thus, a user can set the pressure regulator 434 to either a negligible pressure or at least 30 PSI, which is outside of the operating range of a paint-spraying spray gun system.

These input pressures for system 400 can be configured differently from other spray gun system used to spray paint. For example, the higher input pressure at spray gun gas inlet 436 during a spray operation, if applied to a spray-painting application, can result in an excessive atomization of paint, and decrease the transfer efficiency of the spray gun system. In at least one embodiment, the transfer efficiency of the system 400 using adhesive can be at least 90 percent, or even at least 95 percent. Further, the particle size of the adhesive (when sprayed) can be at least 2 times, at least 3 times, at least 4 times, or at least 5 times larger than the particle size of a paint liquid.

The adhesive cartridge container gas inlet 404 can be formed in a cap 424 that is releasably coupled to the container body portion 426 such that a fluid-tight seal is formed between the cap 424 and the container body portion 426. In at least one embodiment, the adhesive cartridge container 402 can include a plunger that is operated by the gas pressure from the adhesive cartridge container gas inlet 404. In at least one embodiment, the plunger can be responsive to the gas pressure applied through the adhesive cartridge container gas inlet 404 and further apply manual pressure on the container adhesive cartridge, thus forcing out the adhesive and into the nozzle liquid inlet 316. For example, the plunger can be configured to actuate in response to receiving the gas pressure from the gas source.

In at least one embodiment, spray gun platform 422 can also include a hook 428 configured to hang the spray gun platform 422 on a support surface. In at least one embodiment, the adhesive adaptor 314 can have an angle between a spray axis and an axis of the adhesive cartridge container 402, the angle can be configured to allow the adhesive cartridge container 402 to be supported by the hook 428.

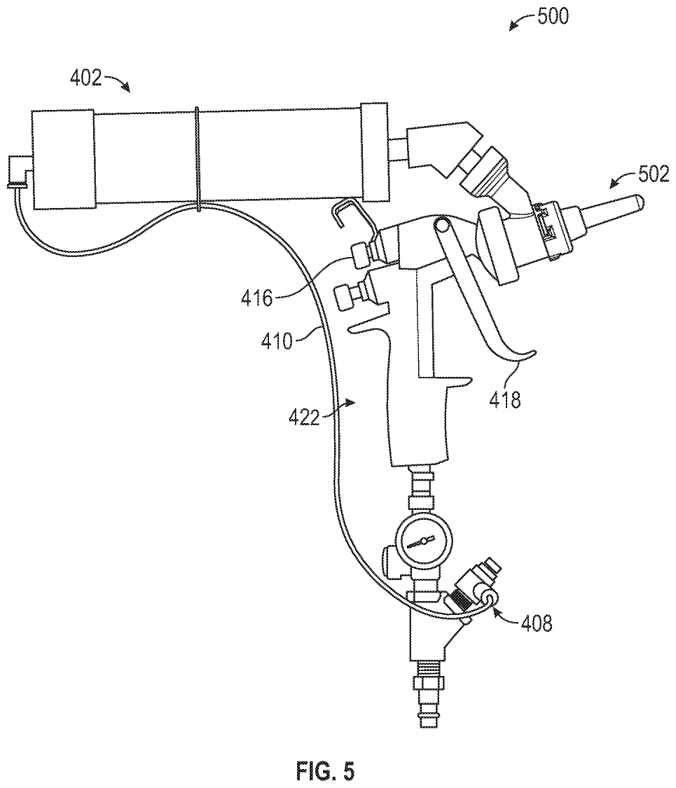

FIG. 5 illustrates a system 500 that is similar to the system 400 in FIG. 4 except that adhesive bead nozzle 502 is used in place of the air cap 304. The system 500 can be used to provide a bead of adhesive. In operation, a user can adjust the shaping gas adjustment knob 416 such that no shaping gas is dispensed from the spray gun nozzle assembly 302. The gas supplied by the gas source can be adjusted at the adhesive cartridge container pressure valve 408 so that the gas is not received by the spray gun platform 422 but flows through the gas tube 410. In operation, the adhesive cartridge container 402 can be pressurized with the gas, as the trigger 418 is pressed, then a needle valve is opened, allowing adhesive in the adhesive cartridge container 402 to flow out through adhesive bead nozzle 502.

Aspects of the present disclosure also allow for the disposable nozzle to have an array of different adhesive bead nozzles 502 that can be attached to the liquid outlet of the spray gun nozzle assembly. These adaptors can vary in design allowing for application appearances ranging from a variety of beaded appearances (circular cross section, ribbon cross section, flat bead, etc.) and a variety of sprayed appearances (looping texture both circular and conical, swirling texture, fine, medium, and coarse splatter textures, etc.). When the user is finished with the application, the adhesive bead nozzle 502 is simply decoupled from the system 400 and disposed of.

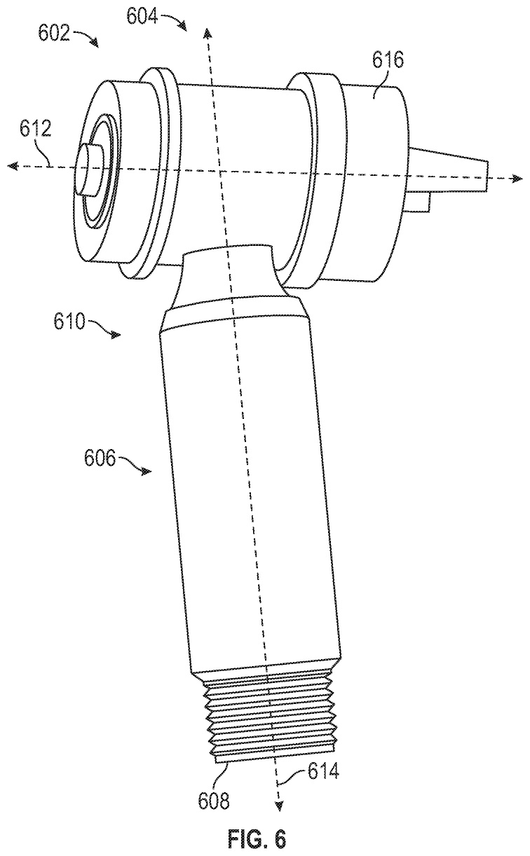

FIG. 6 illustrates an assembly 602 that includes a spray gun nozzle assembly 604, an air cap 616, and an attached adhesive adaptor 606. The spray gun nozzle assembly 604 and air cap 616 can be commercially available under the trade designation Performance Spray Gun, pressure atomizing head by 3M (Saint Paul, MN).

The spray gun nozzle assembly 604 can have a spray axis 612. The adhesive adaptor 606 can have a first connector format at a first end 610 that is configured for a pressure-fed operation. Opposite from the first end 610 can be the second adaptor opening 608. In at least one embodiment, the second adaptor opening 608 can include a connector format for coupling to an adhesive cartridge container. The adhesive adaptor 606 can be arranged along axis 614 that is oblique to the spray axis 612.

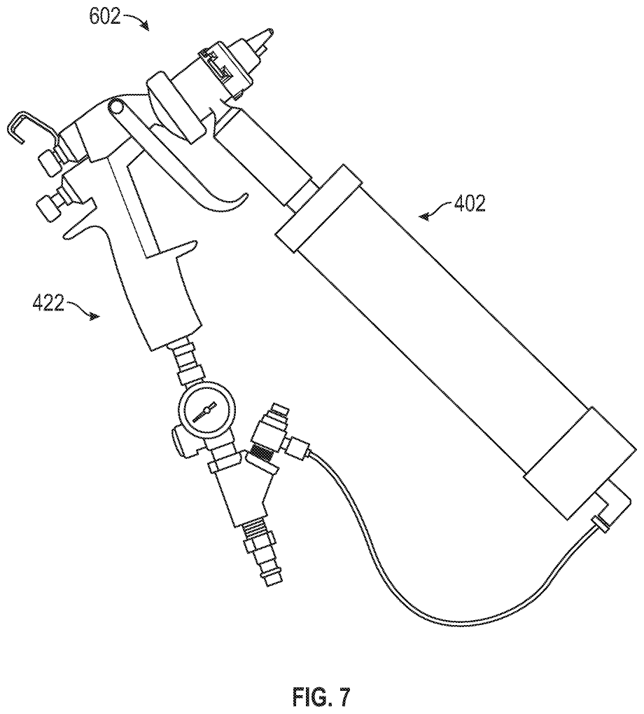

FIG. 7 illustrates a system 700 that includes a spray gun platform 422 and the assembly 602. In addition, the system 700 can include an adhesive cartridge container 402 described herein.

FIG. 8A and FIG. 8B illustrate an assembly 800 that includes an adhesive cartridge container 816 and a spray gun nozzle assembly 828. The spray gun nozzle assembly 828 is configured to couple directly with the adhesive cartridge container 816.

In at least one embodiment, the spray gun nozzle assembly 828 can include a nozzle body portion 830 having a nozzle liquid passageway 824 and nozzle gas passageway formed therein. The nozzle liquid passageway 824 can be formed from the liquid outlet 826 and the liquid inlet 802. A first connector format 806 can be formed adjacent to the liquid inlet 802. As shown, the first connector format 806 is a threaded interface. A rim 832 can form part of the liquid inlet 802. The liquid inlet 802 can further include a projection 820 disposed within the nozzle liquid passageway 824 and oriented toward the adhesive cartridge container 816.

The adhesive cartridge container 816 can include a container body portion 834 with a first container opening 814 and an adhesive cartridge container gas inlet 812 formed therein.

The adhesive cartridge container gas inlet 812 can be configured to receive pressurized gas from a gas source. The first container opening 814 can include a second connector format 810 that is configured to releasably couple with the first connector format 806.

The container body portion 834 can have an internal width dimension 838 and an internal height dimension 836. In at least one embodiment, the internal height dimension 836 can exclude the connector formats proximate to the container openings. In at least one embodiment, the internal height dimension can be at least 2 times, at least 3 times, or at least 4 times the internal width dimension. In at least one embodiment, the internal width dimension 838 and internal height dimension 836 can be dimensioned to receive an adhesive cartridge 818.

The adhesive cartridge 818 can include an attachment format 808 (optional) that is configured to mate with a surface of the adhesive cartridge container 816.

A variety of attachment formats 808 can be used within the adhesive cartridge 818 which may be of different types. For example, the attachment format 808 can be a threaded connection to both the adhesive cartridge container 816 (via second connector format 810) and inlet tubular wall 848 of the spray gun nozzle assembly 828. The adhesive cartridge container gas inlet 812 can also be a quarter turn connection to the inlet tubular wall 848 and the attachment format 808 can be press fit into the adhesive cartridge container 816. In at least one embodiment, the attachment format 808 can include a small collapsing rib on the spout wall 850 to press fit to the adhesive cartridge container 816.

In at least one embodiment, the adhesive cartridge 818 can include a breakable seal 804. As shown, the projection 820 can extend below the rim 832. FIG. 8A illustrates a first configuration where the seal 804 is intact. FIG. 8B illustrate a second configuration where the seal 804 is pierced.

The spray gun nozzle assembly 828 can also include inlet tubular wall 848 which forms part of the liquid inlet 802. The inlet tubular wall 848 can have the first connector format 806 formed therein. The inlet tubular wall 848 can also include the deformable scaling surface 844 on the rim 832. The deformable sealing surface 844 can be configured to contact the adhesive cartridge sealing surface 846 and form a fluid-tight seal against the area surrounding the spout wall 850 of the adhesive cartridge 818. In at least one embodiment, the deformable sealing surface 844 can be configured to compress during assembly and have a sufficient deformation in response to the first connector format 806 being fully engaged with the second connector format 810. In at least one embodiment, the deformation can be at least 0.005″ as measured by the ASTM D695.

In the second configuration, as the first connector format 806 and the second connector format 810 are mated and the adhesive cartridge container 816 is brought closer to the spray gun nozzle assembly 828, then the projection 820 can be configured to puncture/pierce the seal 804. Thus, adhesive cartridge 818 can have a portion that protrudes into the nozzle liquid passageway as the adhesive cartridge 818 is brought toward the spray gun nozzle assembly 828.

FIG. 8B also illustrates a system 840 that includes the assembly 800 and the spray gun platform 842. As assembled, the needle 822 can interfere with a portion of the nozzle liquid passageway 824. In at least one embodiment, the needle 822 can be the only part of the spray gun platform 842 that interacts with the nozzle liquid passageway 824. Thus, a needle valve can be formed with the interaction of the needle 822 and a distal end interior of the nozzle liquid passageway 824 (e.g., liquid outlet 826).

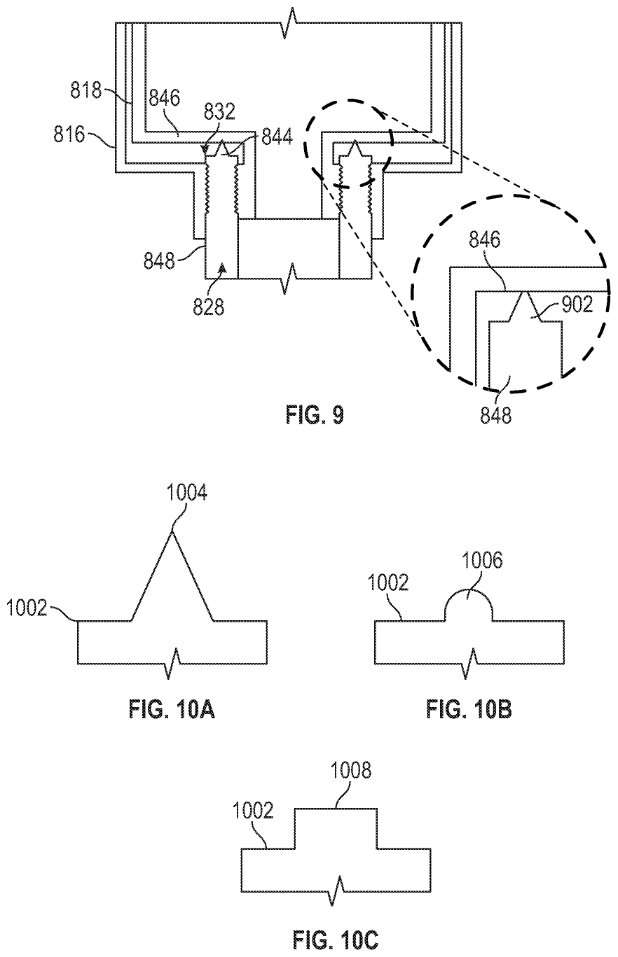

FIG. 9 illustrates an enhanced view of assembly 800 except without the projection 820 shown. Once the inlet tubular wall 848 and adhesive cartridge container 816 are assembled together, then the deformable sealing surface 844 can contact/pierce the adhesive cartridge sealing surface 846. The deformable sealing surface 844 can further deform in response to contacting the adhesive cartridge sealing surface 846 to form the deformed sealing surface 902.

In at least one embodiment, the adhesive cartridge sealing surface 846 can also deformable. For example, adhesive cartridge sealing surface 846 (e.g., a wall that extends radially from an axis of the adhesive cartridge) can have a plastic deformation that is less than the deformation of the deformable sealing surface 844 as measured by ASTM D695.

FIG. 10A, FIG. 10B, and FIG. 10C illustrate example cross-sectional shapes of deformable sealing surfaces. The deformable sealing surface can project distally from the rim surface 110 such that a shelf is formed with the rim surface 110.

FIG. 10A illustrates a deformable sealing surface 1004 having a triangular cross-sectional shape.

FIG. 10B illustrates a deformable sealing surface 1006 having a circular/semi-circular cross-sectional shape.

FIG. 10C illustrates a deformable sealing surface 1008 having a rectangular cross-sectional shape. The deformable sealing surface 1008 can project from rim surface 1002 and form two separate horizontal planes.

FIG. 11A and FIG. 11B illustrate an assembly 1100. The assembly 1100 can be similar to the assembly 800 except that the adhesive cartridge 1112 is different than adhesive cartridge 818 and the projection 1104 is configured different from projection 820.

The assembly 1100 can include a spray gun nozzle assembly 1102 and an adhesive cartridge container 1110. The adhesive cartridge container 1110 can be dimensioned to receive the adhesive cartridge 1112. In at least one embodiment, the adhesive cartridge 1112 is in a sausage-pack format and does not extend into a second connector format 1114.

The spray gun nozzle assembly 1102 can include a nozzle body portion 1108. The nozzle body portion 1108 can include a deformable sealing surface 1106 configured similar to rim 832 except that the projection 1104 protrudes beyond a plane established by the deformable scaling surface 1106. Thus, when assembled in a second configuration shown in FIG. 11B, a distal end of the projection 1104 will extend past the second connector format 1114 and pierce the adhesive cartridge container 1110.

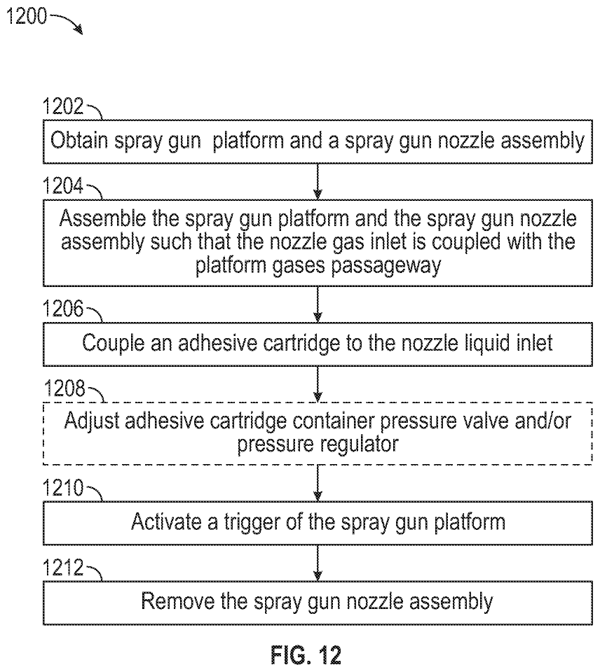

FIG. 12 illustrates a flowchart of a method 1200 of using a spray gun nozzle assembly to dispense an adhesive.

In block 1202, a user can obtain a spray gun platform and a spray gun nozzle assembly. The spray gun nozzle assembly can be detachable from the spray gun platform as described herein. For example, the spray gun nozzle assembly can include a nozzle liquid passageway formed between a nozzle liquid inlet and a nozzle liquid outlet, and a nozzle gas passageway formed between a nozzle gas inlet and a nozzle gas outlet. In at least one embodiment, the nozzle liquid inlet and nozzle gas inlet are not arranged along the same axis.

In at least one embodiment, the spray gun platform includes a platform gas passageway formed therein. The platform gas passageway is configured to fluidically couple to a gas source. In at least one embodiment, the nozzle gas inlet is configured to releasably couple with the platform gas passageway.

In block 1204, a user can assemble the spray gun platform and the spray gun nozzle assembly such that the nozzle gas inlet is coupled with the platform gas passageway. In at least one embodiment, the nozzle liquid outlet is controlled by a needle valve on the spray gun platform and the spray gun platform is not configured to contact the liquid except through the needle valve.

In block 1206, a user can couple an adhesive cartridge configured to contain an adhesive to the nozzle liquid inlet. In at least one embodiment, the adhesive cartridge is configured to be pressurized from the gas source. In at least one embodiment, the user can further pressurize the adhesive cartridge container and/or the adhesive cartridge by attaching a gas source. In at least one embodiment, the coupling of the adhesive cartridge can use features from the spray gun nozzle assembly such as projections and deformable sealing surfaces as described in FIGS. 8-11. For example, the adhesive cartridge sealing surface can be applied or moved toward the deformable scaling surface and contact the deformable sealing surface with the adhesive cartridge scaling surface of the adhesive cartridge to form a fluid-tight seal.

In block 1208, a user can adjust the adhesive cartridge container pressure valve and the pressure regulator of the spray gun system to suit the application. For example, the spray gun system can be configured for providing a bead of adhesive or spraying an adhesive. If providing the bead of adhesive, the pressure regulator can be set to a negligible pressure and the adhesive cartridge container pressure valve can be set to at least 30 PSI. Thus, activating a trigger of the spray gun platform in block 1210 can cause a bead of adhesive to dispense from the spray gun nozzle assembly.

In another example, the spray gun system can be configured for spraying the adhesive. If spraying the adhesive, then the pressure setting at the pressure regulator can be at least 30 PSI, and the pressure at an adhesive cartridge container pressure valve can be no greater than 12 PSI. Thus, in block 1206, activating a trigger of the spray gun platform causes atomized adhesive to dispense from the spray gun nozzle assembly. In at least one embodiment, an average atomized adhesive droplet size can be at least 2 times an average atomized paint droplet size when run through the spray gun platform and spray gun nozzle assembly.

In block 1210, a user can activate a trigger of the spray gun platform. In at least one embodiment, activating the trigger causes the needle valve to open and thereby dispensing the adhesive through the liquid outlet. At least some adhesive residue (either cured or uncured) can remain within the nozzle liquid passageway after block 1210.

In block 1212, the user can remove the spray gun nozzle assembly in order to dispose of the spray gun nozzle assembly and the user can optionally attach a second spray gun nozzle assembly without any adhesive residue (i.e., unused) in place of the first spray gun nozzle assembly.

“Adhesive” refers to a substance for sticking objects or materials together. The term “adhesive” is not intended to refer to a paint having adhesive-like properties. Adhesive can generally have a viscosity of at least 4000 centipoise as measured in accordance with ASTM D2556 (2018), “Test Method for Apparent Viscosity of Adhesives Having Shear Rate Dependent Flow Properties” which may be tested using a Brookfield Viscometer.

“Adhesive cartridge” refers to a self-contained container of adhesive.

“Liquid” refers to a substance that flows freely but is of a constant volume. The adhesive can be a type of liquid.

“Needle valve” refers to a type of valve that uses a needle to control the amount of liquid dispensed from a liquid outlet.

“Negligible pressure” refers to a pressure that is not expected to have a significant impact on delivery of the adhesive. For example, 0 to 1 PSI is considered a negligible pressure.

“Nozzle cartridge” refers to a spray gun component having a self-contained liquid passageway for direct connection to a liquid source/liquid reservoir system and a liquid outlet. When combined with a spray gun platform, the spray gun platform itself does not include the liquid passageway but the spray gun platform can include a portion of a gas passageway for connection to the gas source. Nozzle cartridge can refer to a type of nozzle assembly.

“Pressure regulator” refers to a valve that controls the pressure of a fluid to a desired value using negative feedback from the controlled pressure.

“Restrictor” refers to a two-port valve that reduces the flow as a valve stem is lowered into a valve seat.

“Rigid” refers to containers and other structures that do not collapse as fluid is withdrawn. Moreover, containers and other structures defined as “rigid” may be too stiff to be compressed by manual pressure alone.

“Sausage pack” refers to a packing solution where adhesive is wrapped in an airtight manner with a layer of flexible material such as plastic or foil. The terms “flex-pack”, “foil pack”, “sachet, “burrito pack”, and “sausage pack” can be used interchangeably.

“Spray gun nozzle assembly” refers to a fluid nozzle and a device for coupling the fluid nozzle to a spray gun platform. The nozzle assembly acts to transport a gas through a gas passageway and/or transport a liquid through a liquid passageway formed therein. The gas passageway and/or the liquid passageway of the nozzle assembly is mateable with the gas passageway and/or the liquid passageway of the spray gun platform. In at least one embodiment, the nozzle assembly can include a nozzle cartridge.

“Spray gun platform” refers to a spray gun component that has a grip portion, trigger, and connections to the gas source and optionally a liquid reservoir system. In at least one embodiment, the spray gun platform may refer to a spray gun body with an integrated liquid inlet. In at least one embodiment, the spray gun platform can manually couple to a nozzle cartridge or nozzle assembly.

1. A system, comprising:
a spray gun nozzle assembly comprising a nozzle body portion having a nozzle gas passageway and a nozzle liquid passageway formed therein, the nozzle gas passageway is formed between a nozzle gas inlet and a nozzle gas outlet, the nozzle liquid passageway is formed between a nozzle liquid inlet and a nozzle liquid outlet, the nozzle body portion comprises a first connector format at the nozzle liquid inlet, wherein the nozzle liquid inlet and the nozzle gas inlet are arranged obliquely relative to each other:
an adhesive adaptor having a first end configured to form a fluid-tight connection with the nozzle liquid passageway, the adhesive adaptor having a first adaptor opening formed therein at the first end and a second adaptor opening formed therein opposite of the first adaptor opening at a second end, the first adaptor opening is configured to form a fluid-tight seal with the nozzle liquid inlet; and
an adhesive cartridge container comprising a container body portion further comprising a first container opening and an adhesive cartridge container gas inlet, wherein the first container opening is configured to couple with the second adaptor opening, the adhesive cartridge container gas inlet is configured to receive pressurized gas, the adhesive cartridge container is configured to receive an adhesive cartridge containing an adhesive:
wherein the system, when assembled, is configured to dispense an adhesive having a viscosity of at least 4000 centipoise.

2. The system of claim 1, wherein the first connector format is configured for a pressure-fed operation, the first connector format is arranged along an axis that is oblique to a spray axis.

3. The system of claim 1, wherein the first connector format is configured for gravity-fed operation.

4. The system of claim 1, wherein the adhesive cartridge comprises an attachment format, the adhesive adaptor and/or the adhesive cartridge container comprises complementary attachment format on an inside surface configured to couple with the attachment format.

5. The system of claim 1, further comprising a spray gun platform comprising a platform gas passageway that is configured to couple to the nozzle gas passageway, wherein the nozzle liquid passageway is configured to directly couple to a liquid source outside of the spray gun platform the nozzle liquid passageway is separate from the spray gun platform.

6. The system of claim 1, wherein the adhesive cartridge container comprises a second connector format that is complementary to the first connector format.

7. The system of claim 1, wherein the container body portion comprises a tubular wall.

8. The system of claim 7, wherein the adhesive cartridge container comprises a cap having the adhesive cartridge container gas inlet formed therein.

9. The system of claim 1, wherein the nozzle body portion comprises a projection configured to pierce the adhesive cartridge.

10. The system of claim 9, wherein the nozzle liquid inlet is formed by a spout wall comprising a rim further comprising a deformable sealing surface, wherein the deformable sealing surface does not interfere with the attachment format of the adhesive cartridge when the system is assembled.

11. The system of claim 10, a distal end of the projection protrudes beyond a plane of the rim.

12. The system of claim 1, wherein the adhesive cartridge container has an internal width dimension and an internal height dimension, the internal height dimension is at least 2 times the internal width dimension.

13. The system of claim 1, wherein the adhesive cartridge container comprises a plunger configured to actuate in response to receiving a flow of gas from a gas source.

14. The system of claim 1, further comprising an adhesive cartridge container pressure valve configured to fluidically couple to the adhesive cartridge container gas inlet, wherein the adhesive cartridge container pressure valve is independently adjustable from the spray gun platform, further comprising a splitter that is configured to mate with a pressure regulator and the adhesive cartridge container pressure valve, wherein the pressure regulator is configured to couple with a gas inlet which further couples to the platform gas passageway of the spray gun platform.

15. The system of claim 14, wherein pressure at the adhesive cartridge container pressure valve is configured to be at least 20 PSI when the system is operating.

16. The system of claim 14, wherein during operation, a pressure setting at the pressure regulator is configured to be a negligible pressure, or at least 30 PSI (not inclusive).

17. A method, comprising:
obtaining a spray gun platform and a spray gun nozzle assembly, wherein the spray gun nozzle assembly is detachable from the spray gun platform,
wherein the spray gun nozzle assembly comprises a nozzle liquid passageway formed between a nozzle liquid inlet and a nozzle liquid outlet, and a nozzle gas passageway formed between a nozzle gas inlet and a nozzle gas outlet, wherein the nozzle liquid inlet and the nozzle gas inlet are not arranged along the same axis or coaxially,
wherein the spray gun platform comprising a platform gas passageway formed therein, wherein the platform gas passageway is configured to fluidically couple to a gas source, wherein the nozzle gas inlet is configured to releasably couple with the platform gas passageway;
assembling the spray gun platform and the spray gun nozzle assembly such that the nozzle gas inlet is coupled with the platform gas passageway, wherein the nozzle liquid outlet is controlled by a needle valve on the spray gun platform, the spray gun platform is not configured to contact an adhesive except through the needle valve;
coupling an adhesive cartridge containing the adhesive to the nozzle liquid inlet, wherein the adhesive cartridge is configured to be pressurized from the gas source;
activating a trigger of the spray gun platform, wherein activating the trigger causes the needle valve to open and thereby dispensing the adhesive through the nozzle liquid outlet;
removing the spray gun nozzle assembly from the spray gun platform.

18. The method of claim 17, further comprising: adjusting a shaping gas adjustment knob such that there is no shaping gas flow from an air horn.

19. The method of claim 17, further comprising:
setting a pressure at a pressure regulator to a negligible pressure;
setting a pressure at an adhesive cartridge container pressure valve to at least 30 PSI;
wherein activating the trigger of the spray gun platform causes a bead of adhesive to dispense from the spray gun nozzle assembly.

20. The method of claim 17, further comprising:
setting a pressure at the pressure regulator to at least 30 PSI;
setting a pressure at an adhesive cartridge container pressure valve to no greater than 12 PSI;
wherein activating a trigger of the spray gun platform causes atomized adhesive to dispense from the spray gun nozzle assembly, wherein an average atomized adhesive droplet size is at least 2 times an average atomized paint droplet size when run through the spray gun platform and spray gun nozzle assembly.
